(19) United States
(12) Patent Application Publication
(10) Pub. No.: US 2012/0194449 A1
(43) Pub. Date: Aug. 2, 2012

(54) MOVABLE TOUCH DEVICE AND ELECTRONIC DEVICE THEREOF

(75) Inventor: YUAN-HUA DONG, Shanghai (CN)

(73) Assignees: INVENTEC APPLIANCES (SHANGHAI) CO. LTD., Shanghai (CN); INVENTEC APPLIANCES CORP., SHANGHAI, Shanghai (CN); INVENTEC APPLIANCES CORP., NEW TAIPEI CITY (TW)

(21) Appl. No.: 13/227,477

(22) Filed: Sep. 8, 2011

(30) Foreign Application Priority Data
Jan. 27, 2011 (CN) 201110030244.0

(51) Int. Cl. G06F 3/041

(52) U.S. Cl. 345/173

(57) ABSTRACT

A movable touch device and an electronic device thereof are disclosed. The movable touch device comprises a casing having an external and an opposite internal surfaces; a first conductive layer with a first touch sensor circuit on the external surface of the casing, a second conductive layer with a second touch sensor circuit on the internal surface of the casing, and a communication interface unit installed on the casing for electrically coupling the first and second conductive layers to the electronic device. The movable touch device can be turned over or aligned in parallel to the back of the electronic device. The movable touch device and the display screen can be combined or separated, so that the transmittance of the screen will not be affected, and the electronic device can be removed, so as to provide a convenient carry.

### CROSS-REFERENCE TO RELATED APPLICATION

This application claims the benefit of China Patent Application No. 20110030244.0, filed on Jan. 27, 2011, in the China Intellectual Property Office the disclosure of which is incorporated herein by reference.

### BACKGROUND OF THE INVENTION

1. Field of the Invention

The present invention generally relates to a movable touch device and an electronic device thereof, in particular to a detachable movable touch device and an electronic device thereof.

2. Description of the Related Art

In most of the present touch panels available in the market, a touch panel is mounted onto a display panel, such that users can perform the touch operation on the touch panel after the panel is calibrated, and the program and system of the electronic device convert coordinates of the touch panel into corresponding coordinates of the panel to obtain the result of a corresponding operation.

However, the transmittance of the touch panel of this sort will drop since the surface of the touch panel may be worn out easily after a long time of use. Furthermore, the transmittance of the touch panel is already less than 80%, such that some non-active light emitting display panels (such as the reflective display panel using electronic ink technology) may have a less significant display effect after the touch panel is added, or the touch panel is worn to a level that users can hardly view the content displayed on the panel.

In addition, there is no need for users to use the touch panel as a medium of inputting signals all the time when using an electronic device with a touch operating interface. In other words, most of the time, users just read related information only, thus the touch panel not in use is still mounted onto the electronic device.

### SUMMARY OF THE INVENTION

Therefore, it is a primary objective of the present invention to provide a detachable movable device and an electronic device thereof to achieve the effect of reducing the tear and wear of a touch display panel of a general electronic device.

To achieve the foregoing objective, the present invention provides a movable touch device applicable in an electronic device, and the movable touch device comprises a casing, a first conductive layer, a second conductive layer and a communication interface unit. The casing has an external surface and an internal surface opposite to the external surface, and the first conductive layer is deposed on the external surface of the casing, and a first touch sensor circuit is formed on the external surface of the casing. The second conductive layer is formed on the internal surface of the casing, and a second touch sensor circuit is formed on the internal surface of the casing. The communication interface unit is installed on the casing for electrically coupling the first conductive layer and the second conductive layer to the electronic device.

In a preferred embodiment of the present invention, the foregoing electronic device includes an upper cover coupled to a body of the electronic device by passing a spindle, and a circuit installed inside the spindle and provided for electrically coupling the movable touch device to the electronic device. In addition, the spindle further includes a communication interface slot for passing a communication interface unit of the movable touch device to communication with the electronic device.

In a preferred embodiment of the present invention, a start end of the upper cover includes a first sucker-type contact for attaching the upper cover onto the movable touch device. The electronic device includes a second sucker-type contact for attaching the movable touch device onto the electronic device.

In a preferred embodiment of the present invention, the foregoing movable touch device further includes an optical-level transparent protective film coated onto the external surface of the casing.

In a preferred embodiment of the present invention, the foregoing casing is a glass carrier board with a high heat resisting performance.

In a preferred embodiment of the present invention, the first conductive layer and the second conductive layer as mentioned above are formed on the external surface and the internal surface of the casing by exposing, developing and etching process of the circuit forming, and a plurality of capacitor cases are formed among interlaced meshes.

To achieve the foregoing objective, the present invention further provides an electronic device comprises a main body, a processing unit and a movable touch device, wherein the movable touch device comprises a casing, a first conductive layer, a second conductive layer and a communication interface unit. The casing has an external surface and an internal surface opposite to the external surface. The first conductive layer is deposed on the external surface of the casing, and a first touch sensor circuit is formed on the external surface of the casing. The second conductive layer is disposed on the internal surface of the casing, and a second touch sensor circuit is formed on the internal surface of the casing. The communication interface unit is installed on the casing for electrically coupling the first conductive layer and the second conductive layer to the electronic device.

In a preferred embodiment of the present invention, the foregoing electronic device further includes an upper cover coupled to the main body through a spindle which includes a circuit installed therein, wherein the movable touch device is electrically coupled to the processing unit through the circuit.

The movable touch device and the electronic device thereof according to the present invention adopt a detachable structure, so that the present invention has the following advantages:

(1) The movable touch device of the present invention can be integrally coupled and covered onto the electronic device, and the movable touch device used for input can be turned over or even aligned in parallel to the back of the electronic device for the input, while the input will not affect the output of the display screen.

(2) The movable touch device and the display screen of the present invention can be combined or separated in a simple and easy manner. When the movable touch device and the display screen are not combined, the transmittance of the display screen will not be affected or lowered.

(3) The movable touch device of the present invention can be separated from the electronic device, and the electronic device can be removed, so as to reduce the volume for carrying the electronic device and provide a convenient carry.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is an exploded view of a movable touch device of the present invention;

FIG. 2A is a cross-sectional view of overlapping an electronic device with a movable touch device in accordance with the present invention;

FIG. 2B is a schematic view of overlapping an electronic device with a movable touch device in accordance with the present invention;

FIG. 3A is a cross-sectional view of removing a movable touch device from as surface of an electronic device in accordance with the present invention; and

FIG. 3B is a schematic view of removing a movable touch device from as surface of an electronic device in accordance with the present invention.

### DETAILED DESCRIPTION OF THE PREFERRED EMBODIMENTS

The technical content of the present invention will become apparent by the detailed description of the following embodiments and the illustration of related drawings as follows.

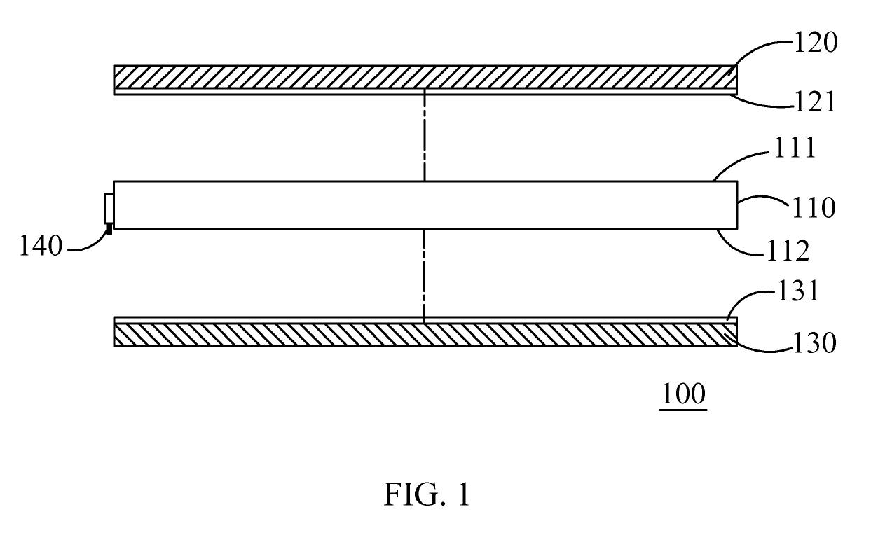

With reference to FIG. 1 for an exploded view of a movable touch device in accordance with the present invention, the movable touch device 100 is applicable for an electronic device, and the movable touch device 100 comprises a casing 110, a first conductive layer 120, a second conductive layer 130 and a communication interface unit 140. The casing 110 has an external surface 111 and an internal surface 112 opposite to the external surface 111, and the first conductive layer 120 is disposed on the external surface 111 of the casing 110, and a first touch sensor circuit 121 is formed between the external surface 111 of the casing 110 and the first conductive layer 120. The second conductive layer 130 is formed on the internal surface 112 of the casing 110, and a second touch sensor circuit 131 is formed between the internal surface 112 of the casing 110 and the second conductive layer 130. The communication interface unit 140 is disposed on the casing 110 for electrically coupling the first conductive layer 120 and the second conductive layer 130 to the electronic device.

In this preferred embodiment, the movable touch device 100 further includes an optical-level transparent protective layer coated onto the external surface 111 of the casing 110.

In this preferred embodiment, the casing 110 is a glass carrier with a high heat-resisting performance.

In this preferred embodiment, the first conductive layer 120 and the second conductive layer 130 are formed on the external surface 111 and the internal surface 112 of the casing 110 by exposing, developing and etching process of the circuit forming, and a plurality of capacitor cases are formed among interlaced meshes.

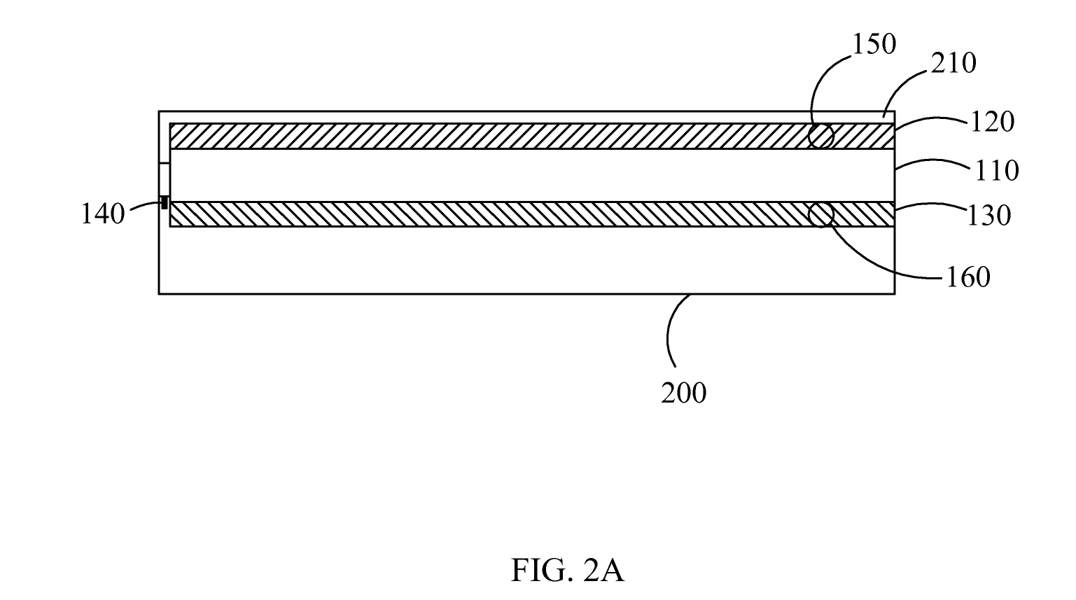

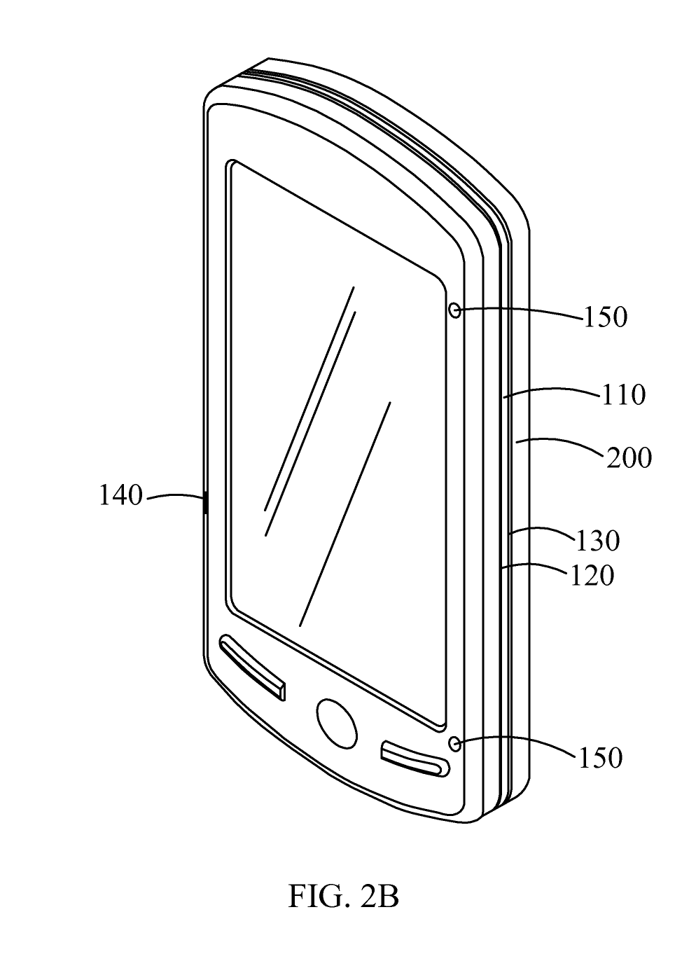

With reference to FIGS. 2A and 2B for a cross-sectional view and a schematic view of overlapping the electronic device of the present invention with the movable touch device respectively. The electronic device 200 includes an upper cover 210, coupled to the casing of the electronic device 200 by passed through a spindle, and the spindle includes a circuit installed therein for electrically coupling the movable touch device 100 to the electronic device 200 through a circuit. Therefore, if the movable touch device 100 is overlapped and connected to the electronic device 200 and the electronic device 200 is installed at the bottom, and the movable touch device 100 is inserted at the middle, the external surface 111 of the casing 110 and the first conductive layer 120 formed on the external surface 111 of the casing 110 are attached onto the upper cover 210 of the electronic device 200, and the internal surface 112 of the casing 110 and the second conductive layer 130 formed on the internal surface 112 of the casing 110 are attached onto a surface of the electronic device 200.

In addition, the spindle further includes a communication interface slot for passing the communication interface unit 140 of the movable touch device 100 in order to communicate with the electronic device 200.

In this preferred embodiment, a start end of the upper cover 210 of the electronic device 200 further comprises a first sucker-type contact 150 provided for attaching the upper cover 210 onto the movable touch device 100. The electronic device 200 includes a second sucker-type contact 160 for attaching the movable touch device 100 onto a surface of a body of the electronic device 200, wherein the electronic device 200 is preferably a mobile phone or a palmtop (such as a PDA).

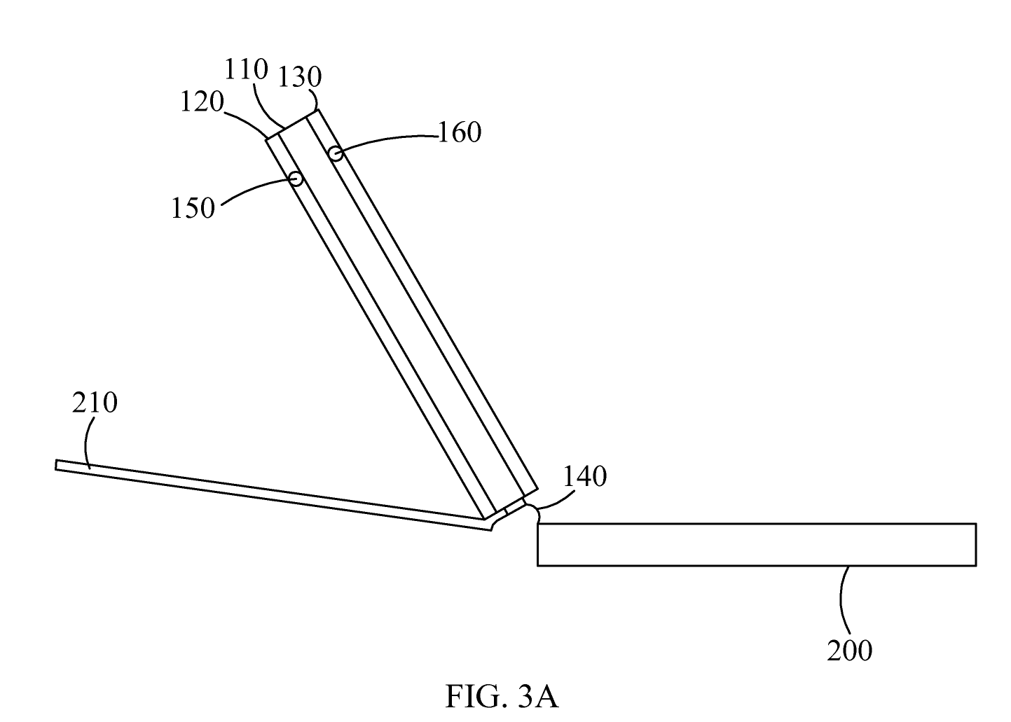

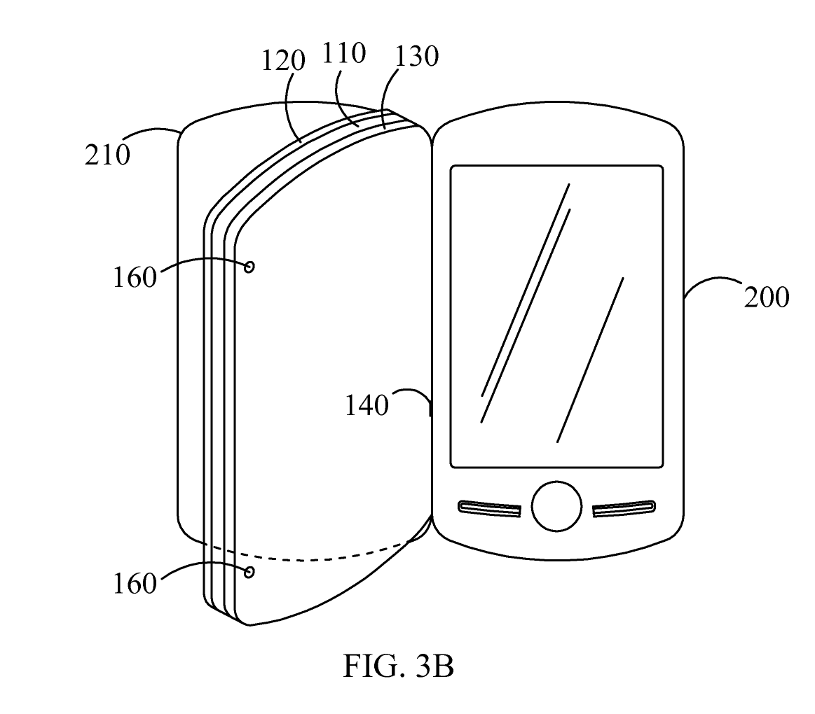

With reference to FIGS. 3A and 3B for a cross-sectional view and a schematic view of removing a movable touch device of the present invention from a surface of an electronic device respectively, this preferred embodiment shows screens of the movable touch device 100 and the electronic device 200. The screens are not an integral body, but the movable touch device 100 is installed in the electronic device 200 and its upper cover 210 through a single shaft, and the movable touch device 100 can be turned over, so that a user can input data or instructions from the integrated body of the movable touch device 100 as a touch panel and the display screen of the electronic device 200 directly in the same way like the traditional touch panel.

In addition, after the movable touch device 100 is turned over, the display screens of the movable touch device 100 and the electronic device 200 are arranged in parallel to one another for the input, or a user can even turn the movable touch device 100 in 360 degrees and then enter data or instructions from a distal surface at the back of the electronic device 200. If it is not necessary to input an instruction from the electronic device 200, the user can separate the movable touch device 100 from the electronic device 200 to achieve the optimal definition of the electronic device 200. If it is necessary to use the movable touch device 100 for the input, then the user simply needs to reinstall the movable touch device 100 into the electronic device 200.

From above, the movable touch device of the present invention can be installed in any electronic devices, such that the electronic device includes the movable touch device. Specifically, the electronic device comprises a main body, a processing unit and the movable touch device. The detail description of the movable touch device has described as mentioned above, and therefore not repeated herein. Additionally, the electronic device having the movable touch device according to the present invention further comprises an upper cover coupled to the main body through a spindle which includes a circuit installed therein, and the movable touch device is electrically coupled to the processing unit through the circuit.

In summation of the description above, the movable touch device of the present invention can be integrally coupled and covered onto the electronic device, and the movable touch device provided for the input can be turned over, or even aligned in parallel to the back of the electronic device for the input. In the meantime, the output from the display screen will not be affected when the input takes place. The movable touch device and the electronic device can be combined and separated easily, and the carry space of the electronic device can be removed to provide a convenient carry. In addition, when the movable touch device and the electronic device are not combined, the transmittance of the display screen of the electronic device will not be reduced.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A movable touch device, applicable for an electronic device, comprising:
a casing having an external surface and an internal surface opposite to the external surface;
a first conductive layer disposed on the external surface of the casing and having a first touch sensor circuit formed on the external surface of the casing;
a second conductive layer disposed on the internal surface of the casing and having a second touch sensor circuit formed on the internal surface of the casing; and
a communication interface unit installed on the casing for electrically coupling the first conductive layer and the second conductive layer to the electronic device.

2. The movable touch device of claim 1, wherein the electronic device includes an upper cover coupled to a main body of the electronic device through a spindle, and the spindle includes a circuit installed therein, and the movable touch device is electrically coupled to the electronic device through the circuit.

3. The movable touch device of claim 2, wherein the spindle further includes a communication interface slot, such that the communication interface unit of the movable touch device communicates with the electronic device through the communication interface slot.

4. The movable touch device of claim 2, wherein the upper cover includes a first sucker-type contact disposed at a start end of the upper cover, such that the upper cover is able to be attached onto the movable touch device.

5. The movable touch device of claim 1, wherein the electronic device includes a second sucker-type contact, such that the movable touch device is able to be attached onto the electronic device.

6. The movable touch device of claim 1, further comprising an optical-level transparent protective film coated onto the external surface of the casing.

7. The movable touch device of claim 1, wherein the casing is a glass carrier board with a high heat resisting performance.

8. The movable touch device of claim 1, wherein the first conductive layer and the second conductive layer are formed on the external surface and the internal surface of the casing by exposing, developing and etching process of the circuit, and a plurality of capacitor cases are formed among intersected net wires.

9. An electronic device, comprising:
a main body;
a processing unit; and
a movable touch device, comprising:
a casing having an external surface and an internal surface opposite to the external surface;
a first conductive layer disposed on the external surface of the casing and having a first touch sensor circuit formed on the external surface of the casing;
a second conductive layer disposed on the internal surface of the casing and having a second touch sensor circuit formed on the internal surface of the casing; and
a communication interface unit installed on the casing for electrically coupling the first conductive layer and the second conductive layer to the processing unit.

10. The electronic device of claim 9, further comprising an upper cover coupled to the main body through a spindle which includes a circuit installed therein, wherein the movable touch device is electrically coupled to the processing unit through the circuit.
